(19) United States
(12) Patent Application Publication
(10) Pub. No.: US 2025/0202332 A1
(43) Pub. Date: Jun. 19, 2025

(54) MOTION CONVERTING DEVICE

(71) Applicant: Edwards Vacuum LLC, Sanborn, NY (US)

(72) Inventor: Nicholai William Salovich, Hillsboro, OR (US)

(21) Appl. No.: 18/847,968

(22) PCT Filed: Mar. 15, 2023
(86) PCT No.: PCT/IB2023/052522

§ 371 Date: Sep. 17, 2024

(30) Foreign Application Priority Data
Mar. 24, 2022 (GB) 2204135.4

(51) Int. Cl. H02K 49/10; H02K 7/06; H02K 7/12

(52) U.S. Cl. CPC H02K 49/102; H02K 7/06; H02K 7/125

(57) ABSTRACT

A device for converting between motion in one direction and motion in another direction is disclosed. The device comprises: a magnetic protrusion or patch mounted on a first movable element and comprising a surface; and a track with predefined magnetic properties mounted on a further movable element, said track defining a pathway towards which said magnetic protrusion or patch is attracted by magnetic forces, said magnetic forces constraining said movable elements to move such that said magnetic protrusion or patch travels in a direction along said magnetic track in response to relative movement between said first and further elements.

### CROSS-REFERENCE TO RELATED APPLICATION

This application is a Section 371 National Stage Application of International Application No. PCT/IB2023/052522 filed Mar. 15, 2023, and published as WO 2023/180876 A1 on Sep. 28, 2023, the content of which is hereby incorporated by reference in its entirety and which claims priority of British Application No. 2204135.4, filed Mar. 24, 2022.

### FIELD

The field of the invention relates to a device for converting motion in one direction to motion in another.

### BACKGROUND

Mechanisms that act to convert motion in one direction to motion in another, such as Scotch Yokes that convert between rotational and linear motion are known. They comprise a pin that extends from a wheel into a linear slot that extends perpendicularly from a rod. Rotation of the wheel causes the pin to move up and down in the slot and to push it from side to side, which results in reciprocating linear motion of the rod results. Drawbacks of such mechanisms arise from the friction and wear between the relatively moving parts, such as the pin and the slot in the Scotch Yoke.

The discussion above is merely provided for general background information and is not intended to be used as an aid in determining the scope of the claimed subject matter. The claimed subject matter is not limited to implementations that solve any or all disadvantages noted in the background.

### SUMMARY

An aspect provides a device for converting between motion in one direction and motion in another direction, said device comprising: a magnetic protrusion or patch mounted on a first movable element and comprising a surface; and a track with predefined magnetic properties mounted on a further movable element, said track defining a pathway towards which said magnetic protrusion or patch is attracted by magnetic forces, said magnetic forces constraining said movable elements to move such that said magnetic protrusion or patch travels in a direction along said magnetic track in response to relative movement between said first and further elements; wherein said surface of said magnetic protrusion or patch comprises a shape with a width dimension that aligns with a width of said track and differs therefrom by less than 30% and a length dimension perpendicular to said width dimension that is substantially shorter than a length dimension of said track, being less than 30% of said length of said track.

Devices that convert between motion in different directions, and in particular between linear and rotational movement are very important in many industrial fields. These devices suffer from wear and friction where the surfaces contact each other. This can lead to damage and failure of the device as well as inefficiencies in its operation. The invention seeks to address these problems by using magnetic forces rather than mechanical forces to constrain the movement and thereby reduce friction and wear. Thus, what might previously have been a slot and pin arrangement is replaced with a magnetic protrusion or patch and a track with predefined magnetic properties, that act to attract the magnetic patch or protrusion. The predefined magnetic properties may be a magnet with opposite polarity or a magnetic material with high magnetic permeability compared to the surrounding material.

In some embodiments, the patch or protrusion has similar dimensions to the width of the track so that it is retained within the track and moves from one end to the other, the length of the track being multiple times larger than its width.

In some embodiments said surface of said magnetic protrusion or patch is flat and said track is linear, such that said surface of said patch or protrusion that faces said track is in a plane that is parallel to a plane of a surface of said track.

In some embodiments, said surface of said magnetic patch or protrusion is substantially circular. The width and length of the magnetic patch or protrusion being the diameter of the circle.

In some embodiments the width and length of said surface of said magnetic patch or protrusion are substantially similar, being within 30% of each other, preferably within 20%.

In some embodiments, the width of the patch or protrusion is within 10% of the width of the track.

In some embodiments, said motion in said one direction comprises rotational motion and said motion in said another direction comprises translational motion

In some embodiments, said travel of said further movable element comprises a reciprocating movement.

In some embodiments, one of said movable elements is configured to be externally driven.

In some embodiments, said magnetic protrusion or patch may have a single pole, while in others said magnetic protrusion or patch comprises at least two poles facing said track.

Where the magnetic protrusion or patch has at least two poles facing the track then the magnetic field extending from the magnetic protrusion or patch may preferentially lie within said track, such that it extends into the track and back round to the other pole of the magnet and is thereby confined to some extent and inefficiencies that may arise due to eddy currents and magnetic hysteresis losses that might arise were the magnetic field not to be confined in this way are reduced.

In some embodiments, said magnetic protrusion or patch comprises an axis perpendicular to said surface, and said magnetic protrusion or patch is symmetrical about said axis or mounted so as be rotatable about said axis.

In order for the magnetic patch or protrusion to travel along the track and for the magnetic field to stay aligned where there are multiple poles, then the magnetic patch or protrusion may be symmetrical about the axis perpendicular to the surface of the patch or protrusion, in some cases rotationally symmetric, and where it is not then the magnetic protrusion or patch may be mounted on a rotational joint such that it can stay aligned.

In some embodiments, said magnetic protrusion or patch comprises a horseshoe magnet, and said magnet is mounted such that it is configured to rotate about an axis running in a direction perpendicular to said surface between said two magnetic poles.

As noted previously, where the magnetic patch or protrusion is not symmetrical about an axis then in order to maintain alignment during the different relative motions between the magnet and the track, a rotational mounting of the magnet may be used.

In some embodiments, said track comprises at least two tracks such that each pole of said at least two pole magnet faces a respective track.

Where the magnet patch or protrusion is a multiple pole magnet then it may be advantageous to have multiple tracks with a track facing each of the poles.

In some embodiments, said magnetic patch or protrusion comprises a permanent magnet, while in other embodiments, said magnetic patch or protrusion comprises at least one electromagnet.or at least one electro permanent magnet.

A permanent magnet may be used or an electro permanent magnet whose magnetic properties may be turned on or off by the use of an electric current. Alternatively an electromagnet may be used as the magnetic protrusion.

An electro permanent magnet and an electromagnet both have the advantage of being controllable, but the drawback of requiring electrical circuitry and in some cases control circuitry associated with them. Thus, the selection of type of magnet will depend on the application.

In some embodiments, said device comprises a plurality of electromagnets or electro permanent magnets mounted at different positions on said first movable element, said device comprises control circuitry configured to activate one of said plurality of electromagnets or electro permanent magnets at any one time, a selection of said one of said plurality of magnets to be activated defining a trajectory of one of said movable elements.

One advantageous use of electromagnets or electro permanent magnets may be that an adaptable device that offers the possibility of different trajectories depending on which of the magnets is activated at any one time can be provided.

In some embodiments, said first movable element comprises a rotatable disk and said plurality of electromagnets or electro permanent magnets are mounted at different radial positions on said rotatable disk.

Where, the first movable element is a rotatable disk then mounting the different electromagnets at different radial positions allows for the length of the translation experienced by the further moveable element to be changed.

In some embodiments, said least one track with predefined magnetic properties is formed by lithographic patterning of a high permeability material on a low permeability substrate.

Providing tracks with predefined magnetic properties can be done using lithographic printing of a high permeability material onto a low permeability substrate and this provides a low cost device where the shape and length of the track can be easily customised depending on requirements.

Furthermore, the low permeability substrate may be a circuit board and where there are multiple intersecting tracks this allows switching and control elements to be mounted alongside the high permeability tracks. Along a given direction of travel then, during the course of its motion, the patch or protrusion will approach various intersections of said multiple tracks. The high permeability track material at any given exit point can be driven into saturation by the control circuitry mounted next to it. If all exit points but one are saturated, the patch or protrusion will be channeled to the unsaturated exit, as the most energetically favourable option. The switching may be used to control the saturation of the tracks and allow switching between paths based on the saturation of the tracks that can be controlled by the control circuitry with conducting switching.

In some embodiments, said at least one track with predefined magnetic properties has a thickness of less than 3 mm.

A thin track may be less expensive to make and provide adequate properties. Where a track is lithographically printed for example, then a thin track with suitable properties is easily achievable.

In some embodiments, the device comprises a sliding joint, in some embodiments, a cam follower or in others a Scotch Yoke.

In some embodiments, said device comprises an additional movable element corresponding to said first movable element, said additional element comprising a magnetic patch or protrusion corresponding to said magnetic patch or protrusion of said first movable element, said additional movable element being mounted on an opposite side of said further movable element to said first movable element.

In some cases, it may be advantageous to have a movable element corresponding to the first movable element and mounted on the opposite side of the further movable element such that the further movable element is not just pulled towards the first movable element but has a corresponding force pulling in the opposite direction, such that the two forces substantially cancel each other out and there is no, or minimal force acting perpendicularly to the direction of travel along the track.

In some embodiments, said device further comprises a hermetic seal between said first and further element.

One advantage of having a non-contact joint is that it allows a hermetic seal to be placed between the two elements and in certain applications this can be particularly advantageous. For example, where the device is used in an environment where there is a pressure difference such as in vacuum pump applications, or where hazardous materials are being handled. A non-contact joint allows the two elements which may be interacting with different parts of the system to be isolated from each other by the use of a hermetic seal placed between them.

A further aspect comprises a cryocooler wherein rotational movement from a motor is converted to reciprocating motion by a device according to one aspect. In some embodiments the reciprocating motion drives the piston of a Gifford-McMahon type cyclic process. In some embodiments the cryocooler forms a part of a cryopump.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows a Scotch Yoke according to an embodiment;

FIG. 2 shows a view from above the Scotch Yoke of FIG. 1;

FIG. 3 schematically shows the magnetic field generated by a magnet facing a pole piece and with magnetic poles at opposite ends of the magnet;

FIG. 4 schematically shows the magnetic field generated by a magnet with two magnetic poles at a same end;

FIGS. 5A and 5B schematically shows the magnetic field generated by a horseshoe magnet facing a single track and a dual track pole piece;

FIG. 6 shows a Scotch Yoke according to a further embodiment; and

FIG. 7a shows a Geneva wheel mechanism that acts as a type of gear converting a continuous rotational movement into intermittent rotary motion in the opposite direction.

FIG. 7B shows a 6 bar sliding mechanism.

FIG. 7C shows a 5-bar slotted mechanism.

FIG. 7D shows a cam follower.

### DETAILED DESCRIPTION

Before discussing the embodiments in any more detail, first an overview will be provided.

Since the inventions of James Watt, efficient conversion between rotational and linear motion has been a critical area of industrial development. While such an important topic has unsurprisingly seen much invention and development, the simple Scotch-Yoke remains a commonly chosen solution due to its simplicity robustness, and in fact is used as key element in some cryocooler vacuum pumps. The conventional Scotch-Yoke drives an appropriately shaped sliding joint with a contact point attached to the rotating drive wheel. Notably, the kinematic path taken by the slider can be tuned by alterations of the slot; which can for example be used to tune the dwell time at either end of the sliding motion.

Although there are many advantages to such a conventional scotch yoke there are also disadvantages due to wear and friction. Embodiments seek to use magnetic forces as the forces used to convert the motion and thereby reduce or eliminate friction between contacting moving parts. The use of the strong interactions between magnetic poles instead of direct mechanical contact offers substantial reductions in friction and wear and is more robust against damage.

Embodiments provide a non-contact magnetic reluctance based mechanism for efficient transformation between rotary and linear motion.

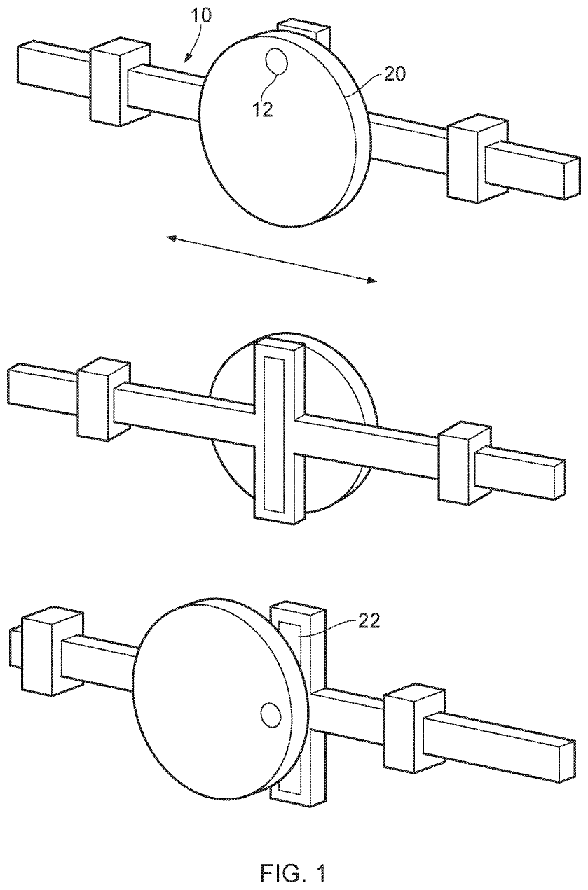

FIG. 1 shows a Scotch Yoke according to an embodiment, where a rod 10 moves to and fro as wheel 20 rotates. Wheel 20 has a permanent magnet “pin” 12. Rod 10 has a high permeability pole piece 22 that corresponds to the “slot” of a conventional Scotch Yoke. In this case the high permeability of the pole piece 22 makes it energetically favourable for the magnet pin 12 to remain centred above the pole piece 22 whereas movement along the long axis of the pole piece is energetically neutral until the magnet reaches either end.

Any losses in such a non-contacting joint may take the form of eddy current dissipation or magnetic hysteresis losses. Fortunately, there are well known ways to mitigate such effects. The power lost due to eddy current generation scales as the resistivity of the material in which currents are being generated, hence it may be advantageous to form portions of the device where eddy currents may be a problem of a highly resistive material. Where high permeability and high resistance are required then a material such as highly resistive Silicon Iron may be chosen. Further reductions in eddy current losses may be achieved by moving to any one of a number of high permeability sintered powders developed for transformer cores. It is also possible to form the core a laminated stack of multiple thin high permeability layers to reduce eddy currents, just as is done in transformers.

Magnetic hysteresis losses occur when the local orientation of the fields produced by individual domains in a magnet is changed. Such losses are high for magnetically “hard” materials whose domains are more difficult to alter and low for magnetically “soft” materials. For this reason transformer cores typically use “soft” materials to minimize such losses, and thus so should noncontact joints. It should also be noted that losses are typically worse when the field direction completely reverses as in the case in a transformer. In a magnetic sliding joint, the external field imposed on any particular point of the slider would never completely reverse, it would simply be ramped up to its peak value and then ramped down as the magnetic “pin” is swept across it.

Thus, direct incorporation of such a magnetic sliding joint into a Scotch Yoke is both effective and straightforward. At the midpoint of the Yoke's rotation the force from the rotating member is transmitted to the slider through the natural proclivity of the pole piece to remain centred above the permanent magnetic “pin”. At either end point of the Yoke's rotation the pin 12 can move easily along the length of the slider 22 because stored magnetic energy is minimized so long as the pin is completely covered by the pole piece. At points in-between there is the same combination of force transmission along the linear motion direction and free sliding in the perpendicular direction that would be seen in a conventional Scotch Yoke, except with reduced friction and no contact.

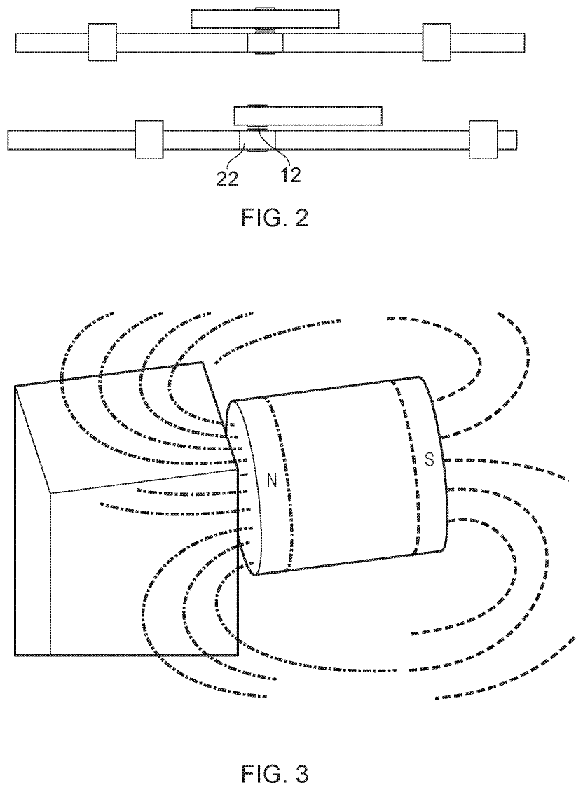

FIG. 2 shows the Scotch Yoke of FIG. 1 from above and as can be seen there is a gap between the pin 12 and slider 22, This gap may allow a hermetic seal (not shown) to be placed between the two movable elements. There may be some applications where it is very desirable to be able to isolate the two sides of the joint and having a non-contact joint means that there is a gap between the two elements which provides space for a hermetic seal.

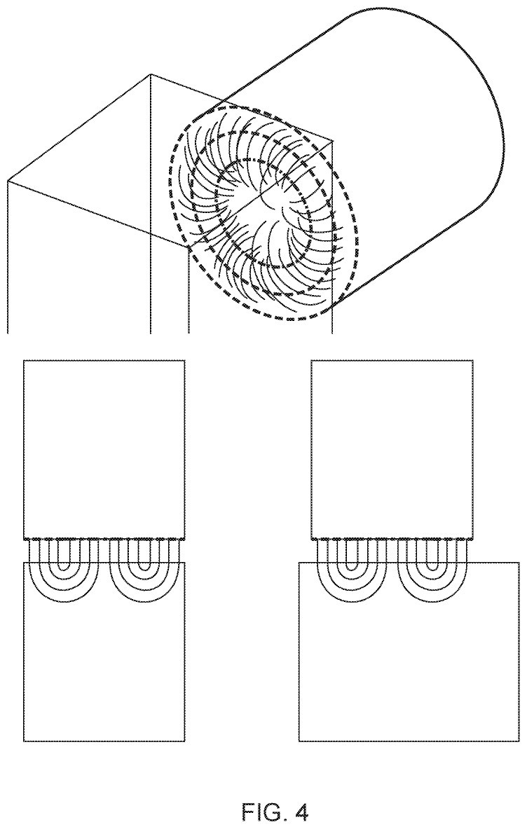

One potential issue with this design is schematically illustrated in FIG. 3 and arises from the ill-defined way in which magnetic fields are routed to the opposite pole once they have traversed the high permeability track. Excessive stray fields can produce eddy current losses on nearby metallic components and potentially cause interference on other components as they vary. Such poorly routed magnetic circuits also reduce the usable connecting force between “pin” and “slider”.

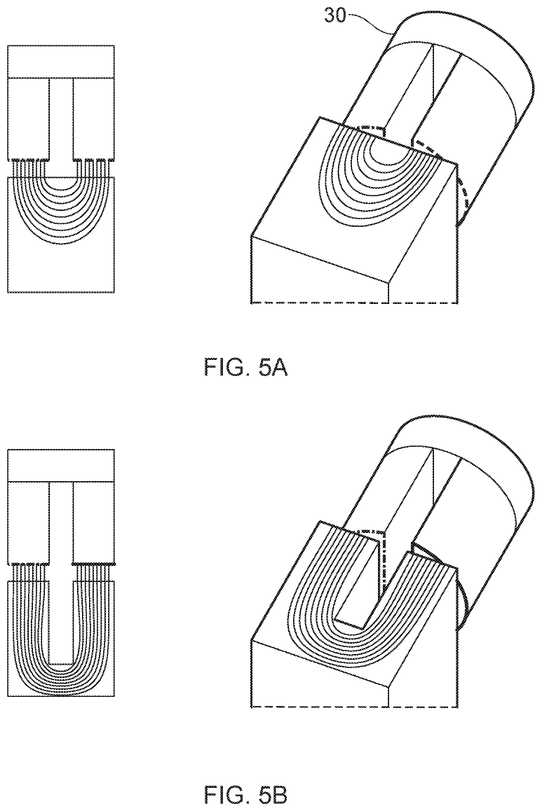

Embodiments seek to address this by using a coaxially split magnetic pole instead of a single pole as shown in FIG. 4. This provides a circularly symmetric closed path for flux, largely eliminating or at least reducing the stray fields. Circular symmetry is necessary in this case because for a fixed “pin” point the relative orientation of the pin will of course rotate through a full rotation relative to the slider each time the drive wheel rotates through a complete rotation.

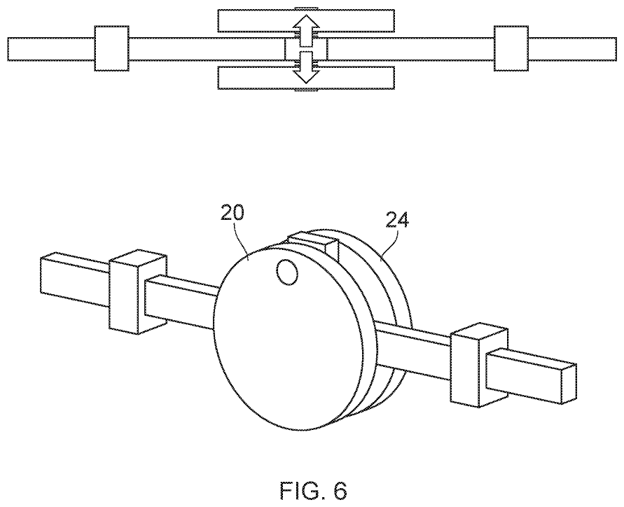

Another possible variation would be to use a “horseshoe” magnet that faced both North and South poles to the high permeability slider see FIG. 5A. This has the benefit of directly completing the overall magnetic circuit thus minimizing or at least reducing stray fields extending from the mechanism but requires that the magnetic pin be housed in a free rotating joint such as provided by a ball bearing.

With fields produced by such a horseshoe magnet, the receiving pole could also be divided into multiple tracks or equivalent receiving “teeth” (see FIG. 5B). Such an interleaving of high field and low field regions will generate greater connecting force between the pin and slider because any lateral displacement of the pin relative to the slider will generate a greater energetic penalty than in the case of a single pole case. This multi-tooth or track scenario can be extended to a larger number of teeth or tracks than two with a multi-pole pin, and a layered stack of sliders.

Another interesting feature of Scotch Yokes is that their relative stroke length can be altered by adjusting the radial position of the pin. Typically this involves additional mechanical complexity in order to be able to dial the pin position in and out. This feature can be incorporated into the non contact magnetic scotch yoke quite easily.

The simplest option is to replace the permanent magnet with an electromagnet and install other electromagnets at different distances long the same radius. Then when the yoke is at its mid-point the driving electromagnet can be turned off, and a coil at a different radius energized, taking over the driving of the slider. Compared to the simple permanent magnet solution, this variation does require the incorporation of multiple electromagnets or electro permanent magnets in the driving wheel and driving circuitry, with related rotating electrical connections. However, it is far simpler than a mechanically variable Scotch Yoke, and can be switched much more quickly; even during a single rotation of the driving wheel.

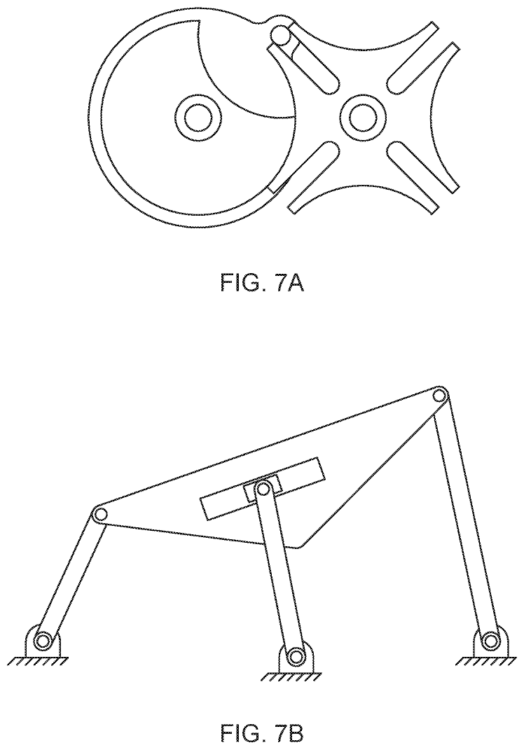

FIG. 6 shows an alternative embodiment of the Scotch Yoke where there is an additional wheel 24 that corresponds to wheel 20 and has a corresponding magnetic pin. Wheel 24 acts to reduce the resultant perpendicular force on the slider 22 due to the magnetic attraction between the magnetic protrusion and slider of wheel 22 by exerting its own force in the opposite direction. Wheel 20 may be a drive wheel, while additional wheel 24 may be a driven wheel.

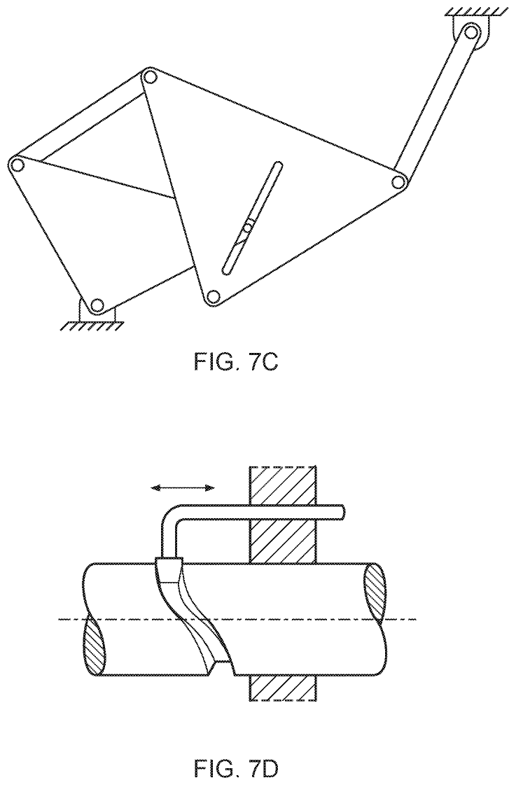

FIG. 7 shows some conventional devices that comprise mechanical sliding joints where the pin could be replaced by a magnetic patch or protrusion and the slot by a high permeability track to produce a device according to an embodiment. Thus, FIG. 7a shows a Geneva wheel mechanism that acts as a type of gear converting a continuous rotational movement into intermittent rotary motion in the opposite direction. FIGS. 7B and 7C show a 6 bar sliding mechanism and a 5-bar slotted mechanism respectively, while FIG. 7D shows a cam follower.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A device for converting between motion in one direction and motion in another direction, said device comprising:
a magnetic protrusion or patch mounted on a first movable element and comprising a surface; and
a track with predefined magnetic properties mounted on a further movable element, said track defining a pathway towards which said magnetic protrusion or patch is attracted by magnetic forces, said magnetic forces constraining said movable elements to move such that said magnetic protrusion or patch travels in a direction along said magnetic track in response to relative movement between said first and further elements; wherein
said surface of said magnetic protrusion or patch comprises a shape with a width dimension that aligns with a width of said track and differs therefrom by less than 30% and a length dimension perpendicular to said width dimension that is substantially shorter than a length dimension of said track, being less than 30% of said length of said track.

2. The device according to claim 1, wherein said motion in said one direction comprises rotational motion and said motion in said another direction comprises translational motion

3. The device according to claim 1, wherein said magnetic protrusion or patch comprises a magnet with at least two poles facing said track

4. The device according to claim 1, wherein said magnetic protrusion or patch comprises an axis perpendicular to said surface, and said magnetic protrusion or patch is symmetrical about said axis or mounted so as be rotatable about said axis.

5. The device according to claim 3, wherein said magnetic protrusion or patch comprises a horseshoe magnet, and said magnet is mounted such that it is configured to rotate about an axis running perpendicular to said surfaces of said magnet facing said track and between said two magnetic poles.

6. The device according to claim 3, wherein said track comprises at least two tracks such that each pole of said at least two pole magnet faces a respective track.

7. The device according to claim 1, wherein said magnetic protrusion or patch comprises a permanent magnet.

8. The device according to claim 1, wherein said magnetic protrusion comprises at least one electromagnet or at least one electro permanent magnet.

9. The device according to claim 8, wherein said device comprises a plurality of electromagnets or electro permanent magnets mounted at different positions on said first movable element, said device comprising control circuitry configured to activate one of said plurality of electromagnets or electro permanent magnets at any one time, a selection of said one of said plurality of magnets to be activated defining a trajectory of one of said movable elements.

10. The device according to claim 9, wherein said first movable element comprises a rotatable disk and said plurality of electromagnets or electro permanent magnets are mounted at different radial positions on said rotatable disk.

11. The device according to claim 1, wherein said at least one track with predefined magnetic properties is formed by lithographic printing of a high permeability material onto a low permeability substrate.

12. The device according to claim 1, wherein said at least one track with predefined magnetic properties has a thickness of less than 3 mm.

13. The device according to claim 1, wherein said further movable element comprises a plurality of tracks, said plurality of tracks defining different relative trajectories between said movable elements.

14. The device according to claim 1, wherein said device comprises one of a cam follower or a scotch yoke.

15. The device according to claim 1, an additional movable element corresponding to said first movable element, said additional element comprising a magnetic patch or protrusion corresponding to said magnetic patch or protrusion of said first movable element, said additional movable element being mounted on an opposite side of said further movable element to said first movable element.

16. The device according to claim 1, wherein said device further comprises a hermetic seal between said first and further element.
